(19) United States
(12) Patent Application Publication
(10) Pub. No.: US 2023/0153771 A1
(43) Pub. Date: May 18, 2023

(54) DYNAMIC DISCOVERY AND APPLICATION OF STORED-VALUE TOKENS

(71) Applicant: Klarna Bank AB, Stockholm (SE)

(72) Inventors: Nicholas Cyrus Mahalec, Los Angeles, CA (US); John David Anderson, Winter Springs, FL (US)

(21) Appl. No.: 17/989,572

(22) Filed: Nov. 17, 2022

Related U.S. Application Data
(60) Provisional application No. 63/280,809, filed on Nov. 18, 2021.

(51) Int. Cl. G06Q 20/06

(52) U.S. Cl. CPC G06Q 20/0655

(57) ABSTRACT

A request for a stored-value token (SVT) usable to apply to a web-based exchange is obtained from an agent executing on a client device of a user, where the request indicates a vendor that is facilitating the web-based exchange. A set of SVT providers supported by the vendor is identified. The SVT for the web-based exchange is determined based on the set of SVT providers and one or more targets, where the SVT represents a quantity of units of a resource. The SVT is obtained from an SVT provider of the set of SVT providers. The agent is caused to apply at least a portion of the quantity of units of the SVT to the web-based exchange by providing the SVT to the agent executing on the client device.

### CROSS-REFERENCE TO RELATED APPLICATION

This application claims the benefit of U.S. Provisional Application No. 63/280,809, filed Nov. 18, 2021, entitled “DYNAMIC DISCOVERY AND APPLICATION OF STORED-VALUE TOKENS,” the disclosure of which is herein incorporated by reference in its entirety.

### BACKGROUND

Goods and services providers (GSPs) often offer stored-value tokens to stored-value token (SVT) providers at a reduction from face value. The stored-value token providers, in turn, frequently offer the stored-value tokens to users for some amount between the face value and the reduced face value. Some GSPs discount their stored-value tokens more heavily, whereas other GSPs may discount their stored-value tokens only by a percentage or two. The problems related to finding a stored-value token (SVT) provider, finding a GSP that accepts stored-value tokens from the SVT provider, applying for and obtaining the stored-value token, and applying the stored-value token in a transaction make using stored-value tokens an arduous process. Additionally, users often do not utilize the full value of the stored-value token, and the unrealized value goes to waste. These problems often discourage users from using the stored-value tokens.

### BRIEF DESCRIPTION OF THE DRAWINGS

Various techniques will be described with reference to the drawings, in which:

FIG. 1 illustrates an example of a system for discovering and applying stored-value tokens in accordance with an embodiment;

FIG. 2 illustrates an example of multiple interfaces a user might use to confirm an application of a stored-value token in accordance with an embodiment;

FIG. 3 illustrates an example of an interface prompting a user to confirm application of a stored-value token in accordance with an embodiment;

FIG. 4 illustrates an example of a confirmation interface in accordance with an embodiment;

FIG. 5 illustrates an example of an agent in accordance with an embodiment;

FIG. 6 is a swim diagram that illustrates an example of identification and application of a stored-value token in accordance with an embodiment;

FIG. 7 is a flowchart that illustrates an example of a SVT facilitator service identifying and applying a stored-value token in accordance with an embodiment; and

FIG. 8 illustrates a computing device that may be used in accordance with at least one embodiment.

### DETAILED DESCRIPTION

Techniques and systems described below relate to a system in which a stored-value token is determined and automatically applied in a transaction between a user and a GSP service (e.g., a merchant/vendor of goods or services). In one example, a request for a stored-value token (SVT) usable to apply to a transaction/exchange is obtained from a software agent running (executing) on a client device of a user. The software agent may be a browser extension/plug-in, standalone software application, or other suitable software agent. The software agent may be provided by SVT facilitator service to the client device for download and installation. In the example, the request indicates a GSP that is facilitating the transaction. In this example, a set of SVT issuers (e.g., producers or providers of SVTs) supported by the GSP is identified. Further in the example, the SVT for the transaction is determined based on the set of SVT issuers and one or more objectives. In the example, the SVT represents a quantity of units of a resource. Still in the example, the SVT is obtained from an SVT issuer of the set of SVT issuers. Finally, in the example, the software agent is caused to apply at least a portion of the quantity of units of the SVT to the transaction by providing the SVT to the software agent executing on the client device.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

In many situations, there are often ways to utilize one or more resources now in order to achieve an overall reduction in expenditure of the one or more resources later. In other words, such resources are advanced to achieve the overall reduction (and such resources may be referred to in the present disclosure as “resource advances” or “resource advancement”). Techniques described and suggested in the present disclosure improve the field of computing, especially the field of resource utilization, by factoring in various advantages and disadvantages of different resource advancements that can produce an overall reduction in expenditure of resources. For example, certain power generators must expend an initial amount of stored energy before they begin producing energy of their own, which can then be used to replenish the stored energy expended. The power generation system may have multiple different sources of stored energy to choose from, and may evaluate different characteristics of the sources to determine the ideal source for the situation. Such power sources may have characteristics such as amount of time needed to recharge, energy capacity, number of times the source can be recharged before it must be replaced, environmental footprint of the energy source, age and predicted lifetime of the energy source, and so on. The power generator may additionally have factors to be evaluated, such as power output, startup time, amount of a resource consumed to produce a unit of power, and so on. The system of the present disclosure is usable to determine, based on the above factors, an optimal energy source for the initial amount of stored energy based on a balance of the considered factors.

Additionally, techniques described and suggested in the present disclosure improve the efficiency of electronic checkouts by automatically determining an optimal SVT to apply to a transaction and automatically applying the SVT without human interaction. Moreover, techniques described and suggested in the present disclosure are necessarily rooted in computer technology in order to overcome problems specifically arising with user experience by improving the convenience, user satisfaction, and speed of finalizing a transaction by determining optimum SVTs and automatically applying them without human interaction.

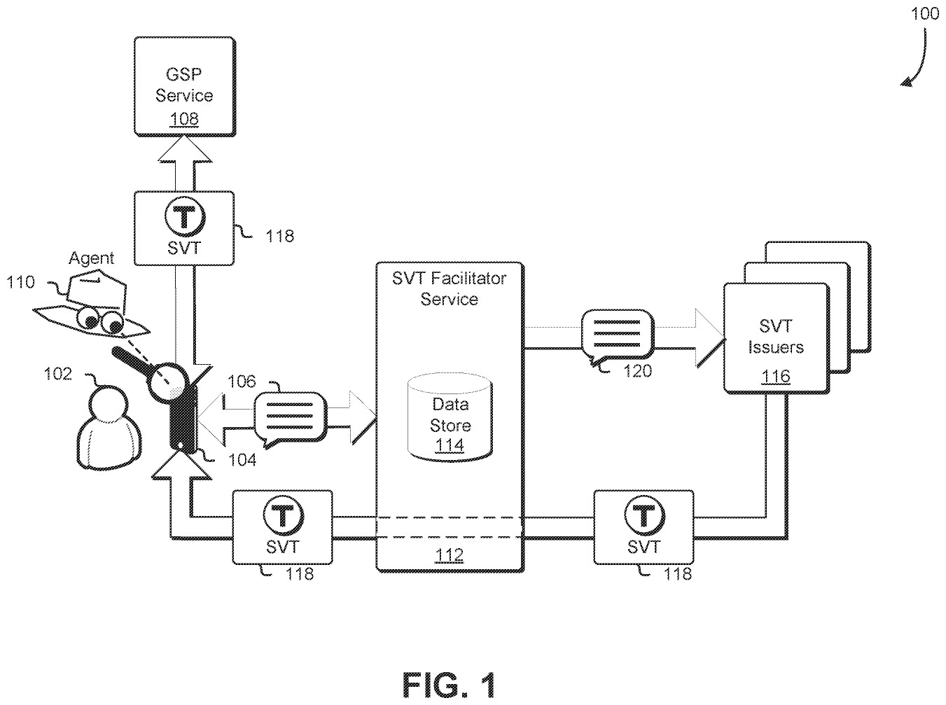

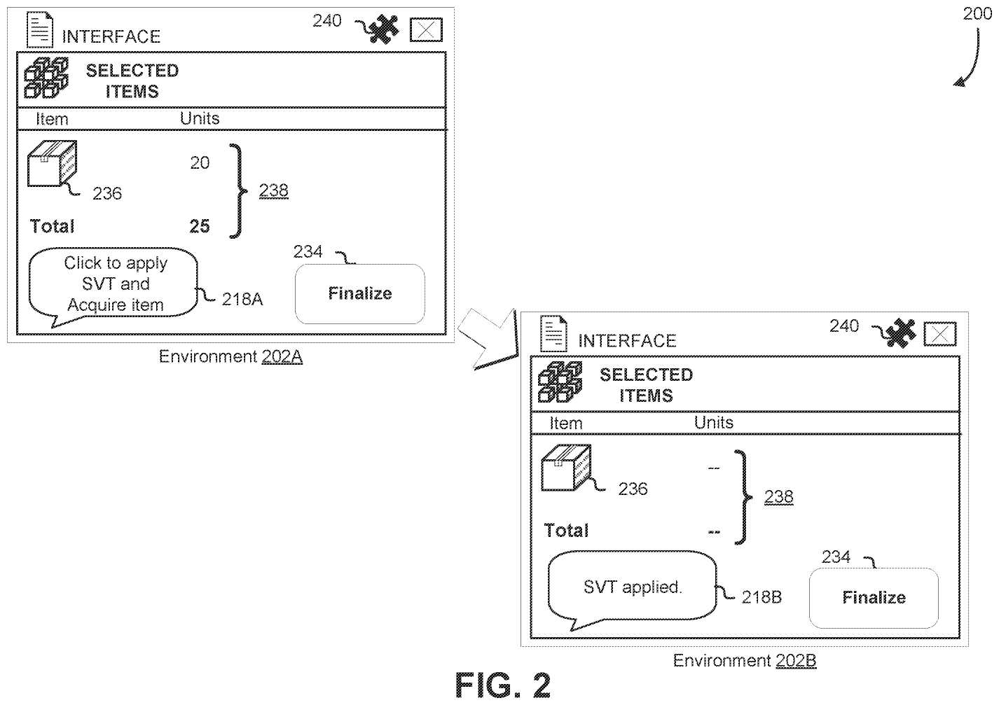

FIG. 1 illustrates an environment 100 in which an embodiment of the present disclosure may be implemented. As depicted in FIG. 1, the environment 100 may include a user 102 interacting with a client device 104, upon which a software agent 110 (also referred to as agent) is running. The software agent 110 may be monitoring interactions of the user (e.g., with a user interface, such as shown in FIGS. 2-4) with a goods and/or services provider (GSP) 108 (also referred to in the present disclosure as a “vendor”) for an opportunity where using/applying a stored-value token (SVT) would be applicable and beneficial (e.g., by utilizing one or more resources in order to achieve an overall optimization of the one or more resources later) to the user 102. In the environment 100, as a result of the software agent 110 detecting such an opportunity, the software agent 110 may cause the client device 104 to submit a request 106, may submit a request 106 to SVT facilitator service 112 for the SVT 118.

Responsive to the request 106, the SVT facilitator service 112 may initiate a process to determine the optimum SVT available from SVT issuers 116, based on a balance of factors or one or more objectives. Once the optimum SVT and SVT issuer is determined, the SVT facilitator service 112 may send a message 120 requesting the SVT 118. When the SVT 118 is obtained from one of the SVT issuers 116, the SVT facilitator service 112 may transfer the SVT 118 to the software agent 110 running on the client device 104. The SVT facilitator service 112 utilizes a data store 114 to store information about the SVT issuers 116 and GSP services, such as the GSP service 108, usable to aid in the determination of the optimum SVT available and may additionally or alternatively utilize the data store 114 to track an initial amount of a resource allocated to the SVT 118 and/or a balance remaining on the SVT 118 (in the event the SVT is only partially exhausted).

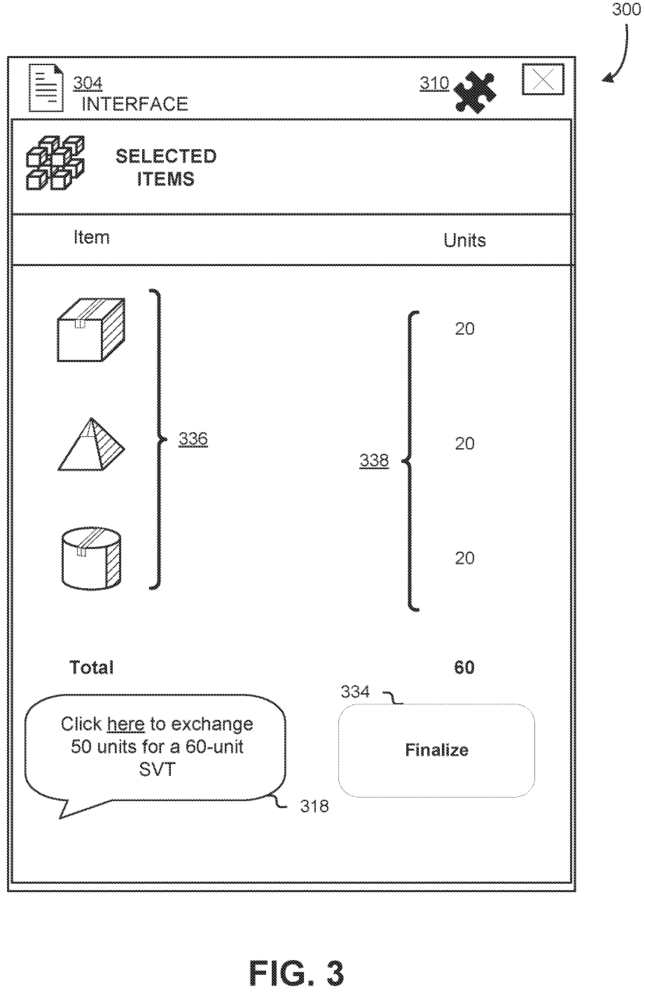

Additionally, or alternatively, prior to obtaining and providing the SVT 118 to the software agent 110, the SVT facilitator service 112 may respond with a notification (not illustrated) to the client device 104 to initiate the process and prompt the user 102 as to whether the user 102 intends to proceed with performance of the process, such as shown in FIGS. 2 and 3. Upon receiving confirmation from the user 102 via the client device 104, the SVT facilitator service 112 may perform a transfer of value (e.g., resource or asset) between the client device 104 and one of the SVT issuers 116 by submitting the message 120 requesting the SVT 118, and, upon receipt of the SVT 118, providing the SVT 118 to the client device 104. Once the software agent 110 running on the client device 104 receives the SVT 118, the software agent 110 may prompt the user whether to use/apply the SVT 118 in the interaction with the GSP service 108.

The user 102 may represent an individual, a group of individuals, a computing system, an executing software application, a computing service, a computing resource, or other entity capable of controlling input to and receiving (e.g., visually, auditorily, etc.) output from the client device 104. The user 102 may have access to a set of user records and/or a profile with the GSP service 108, and may have a set of credentials (e.g., username, password, etc.) registered with the GSP service 108. The user 102 may have access to a set of user records and/or a profile with the SVT facilitator service 112, and may have a set of credentials (e.g., username, password, etc.) registered with the SVT facilitator service 112. In the present disclosure, a “set of user records” refers to a stored set of information at the respective service (e.g., the SVT facilitator service 112, the software agent 110, the GSP service 108, etc.) that allows a user, an entity, or another service to authenticate to the respective service and to receive permission to access resources provided by or connected to the respective service. For example, the user 102 may authenticate to the GSP service 108 or to the SVT facilitator service 112 via the client device 104, to gain access to the resources provided by the software agent 110 or by the SVT facilitator service 112.

The client device 104, in some embodiments, is embodied as a physical device and may be able to send and/or receive requests, messages, or information over an appropriate network. Examples of such devices include personal computers, cellular telephones, handheld messaging devices, laptop computers, tablet computing devices, set-top boxes, personal data assistants, embedded computer systems, IoT devices, electronic book readers, a combination of devices described herein, and any other suitable device which is capable of executing a set of instructions. As depicted in FIG. 1, the user 102 may utilize the client device 104 to interact with a website of the GSP service 108.

The software agent 110 may be provided by the SVT facilitator service 112. The software agent 110 may run as an extension or plug-in to another application (such as a browser) running on the client device 104. Additionally, or alternatively, the software agent may run as a standalone software application on the client device 104 or may be software code integrated with another software application running on the client device. The software agent 110 may send a request 106 to the SVT facilitator service 112 to determine whether an SVT exists that can be applied to the interaction between the user and the GSP service 108. If the SVT facilitator service 112 determines that such an SVT exists, the SVT facilitator service 112 may obtain the SVT 118 and provide it to the software agent 110 running on the client device 104. The client device 104 may then apply (in some embodiments, the software agent 110 prompts the user for confirmation before applying) an amount of the SVT value to the interaction with the GSP service 108.

The GSP service 108 may be a web-based marketplace/exchange that allows a user to obtain virtual or physical resources and/or services from other users of the GSP service 108 or from the GSP service 108 itself. That is, the other users and/or the GSP service 108 itself may be vendors that purvey items or services via a website. In some embodiments, services may include one or more interfaces that enable the user 102 to submit requests via, for example, appropriately configured application programming interface (API) calls. For example, the GSP service 108 may be service for facilitating a transaction between the user 102 and the GSP service 108.

The request 106 may be a request for the SVT 118 to be implemented in the user interaction with the GSP service 108. The request 106 may specify the identity of the GSP service 108, the maximum amount of resource needed (e.g., total amount needed to complete the transaction)), and/or a combination of other factors. The SVT facilitator service 112 might also utilize an algorithm, a service, and/or a machine learning model in order to locate the optimal SVT. For example, the request 106 may specify an amount for the SVT 118 representing a magnitude of energy storage, value of a resource, amount of a resource, etc., usable to determine the optimum SVT to meet the objectives for the SVT 118. The request 106 may further include additional text or a hyperlink (such as a Uniform Resource Locator (URL) of the GSP service 108). The request 106 may be directed by the client device 104 under the control of the user 102 to the SVT facilitator service 112. The request 106 may further include a message, such as a user confirmation to proceed with finding the optimum SVT. The request may be any suitable type of request, such as a Hypertext Transfer Protocol (e.g., GET, POST, etc.) or an API call.

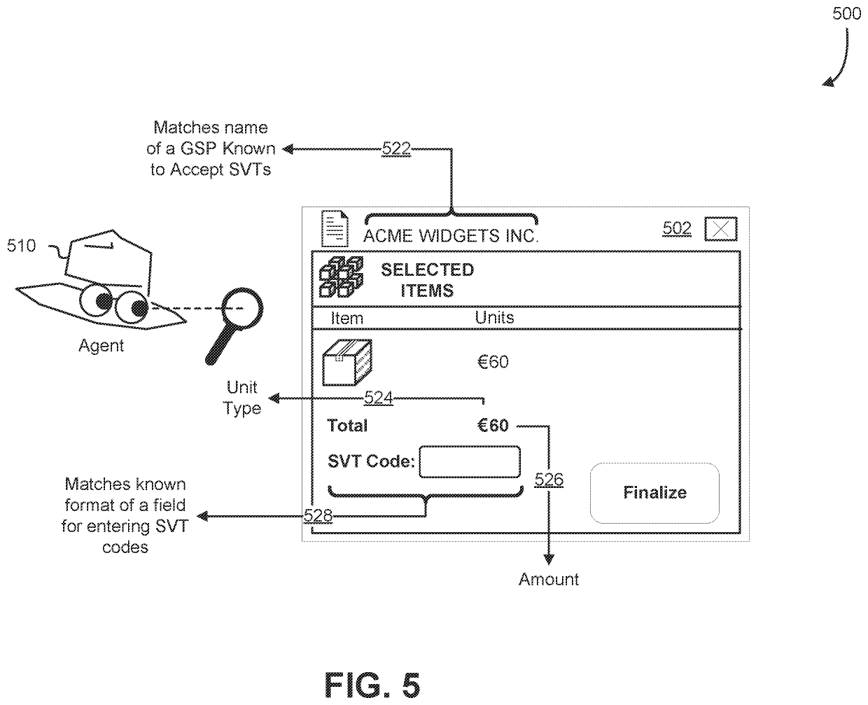

The software agent 110 may be a standalone application or browser extension provided by the SVT facilitator service 112. The software agent 110 may run on the client device 104 and detect an opportunity to apply an SVT during an interaction between the user 102 and the GSP service 108. The software agent 110 may send the request 106 for an SVT to the SVT facilitator service 112 when it detects a match to a filter rule on a website of the GSP service 108. Further details about filter rules can be found in the description of FIG. 5. In some examples, “detect” refers to sense, perceive, identify, discover, ascertain, respond to, and/or receive the existence, presence, and/or fact of. In various embodiments, a “match” does not necessarily require equality. For example, two values may match if they are not equal, but mathematically equivalent. As another example, two values may match if they correspond to a common object (e.g., value) or are in some predetermined way complementary and/or they satisfy one or more matching criteria. Generally, any way of determining whether there is a match may be used.

The SVT facilitator service 112 may be another third-party service to which the user 102 may be subscribed. The SVT facilitator service 112 may facilitate interactions between users and GSP services by providing the software agent 110 to pre-existing applications (e.g., browsers) running on client devices of the users. The software agent 110, when executed, may aid the SVT facilitator service 112 with locating SVTs for the user 102 to apply in an interaction with the GSP service 108.

The data store 114 may be a repository providing non-transitory, persistent (non-volatile) storage for data objects, such as database records, flat files, and other data objects. Examples of data stores include file systems, relational databases, non-relational databases, object-oriented databases, comma-delimited files, and other files. In some implementations, the data store 114 is a distributed data store. The data store 114 may store various records usable by the SVT facilitator service 112 to facilitate interactions between the user 102 and the GSP service 108 as described in the present disclosure. Additionally, or alternatively, the data store 114 may store one or more filter rules associated with the SVT issuers 116. For example, the SVT facilitator service 112 may maintain a list of the SVT issuers 116 that correlates SVTs of the SVT issuers 116 with various GSP services that accept such SVTs. In this manner, the SVT facilitator service 112 may, but is not limited to, use these data stores to determine which SVT issuer is to be the recipient of the transfer of value (e.g., resource or other asset) depending on the filter rule matched by the SVT filtering service 112.

The SVT issuers 116 may be one or more entities that provide/issue SVTs to other entities, such as the SVT facilitator service 112 or the user 102. The SVT issuers may provide/issue the SVT for an amount less than the face value of the actual SVT value. Note that the amount and the face value may be in the same units of exchange (e.g., dollars, kilowatts, etc.). It may be that the GSP service 108 does not accept SVTs from all SVT issuers, so the SVT facilitator service 112 may determine which of the SVT issuers offers an SVT usable with the GSP service 108 and, from those SVT issuers, which provides the SVT 118 that has the optimum balance of desired factors.

The SVT 118 may be a token that represents a certain amount of quantifiable units (stored value). Depending on implementation, the SVT 118 may be represented by an alphanumeric code, a hash value, phrase, or a digital object. In some embodiments, the SVT 118 may be communicated over a network, such as the Internet. In other embodiments, the SVT may be communicated audibly (e.g., by a user speaking the passphrase), visibly (e.g., scanning a barcode or quick response (QR) code, etc.), magnetically (e.g., via a magnetic strip on the back of a card, etc.) or other suitable method. In some other embodiments the SVT 118 may be a physical object (e.g., coin, paper note, electronic device, etc.). In some embodiments, the value may be stored on or within the SVT 118 itself (such as encoded within the digital object or stored in non-transitory, computer-readable media on or within the token), and in other embodiments the SVT 118 may include an identifier and the value is recorded in a database record of an SVT issuer (e.g., one of the SVT issuers 116) in association with the identifier. When the SVT 118 is applied, amounts up to the stored amount may be deducted from the stored amount. The deduction may be recorded in the medium where the amount is stored (e.g., a database record, or on or within the SVT 118 itself, depending on implementation of the SVT). In some embodiments, the SVT 118 may correspond with an alphanumeric code (SVT code), and using/applying the SVT 118 may involve entering (such as by the software agent 110 causing the client device to automatically enter the code) the SVT code into an SVT code field. An example of an SVT code field can be seen in FIG. 5. One example of an SVT is a gift card.

In some embodiments, the SVT 118 is exhausted when its stored value reaches zero. In other embodiments, the stored-value of the SVT 118 may be increased/recharged as needed. In various embodiments, an SVT 118 may be obtained from one of the SVT issuers 116 by providing to the SVT issuer an agreed-upon quantity of units less than the amount of units issued (e.g., face value) of the SVT 118. In such embodiments, the SVT issuer may use the SVT 118 as a guarantee to the recipient to provide the face value of the SVT 118 in exchange for a lesser amount of units now. In one example, a unit is a unit of electrical energy and the SVT issuer may be a power utility that needs additional electrical energy to meet the demands of its users. In this example, the power utility (SVT issuer) may, in exchange for an amount of additional electrical energy needed to meet current demand for electrical energy, guarantee to provide another power utility an even greater amount of electrical energy (the SVT 118) in the future. This other power utility can then use/apply the SVT 118 with the power utility for the amount of electrical energy recorded for the SVT 118 at some date in the future. The SVT 118, once obtained from an SVT issuer, may be provided to the client device 104.

The message 120 may be a request from an appropriate one of the SVT issuers 116 to issue the SVT 118 for the amount determined to achieve the balance of objectives/targets (e.g., greatest difference—fixed or proportional—between face value and amount supplied (expenditure amount) by the user 102, or a lowest amount needed to be provided to the SVT issuer by the SVT facilitator service 112, etc.). The request may be any suitable type of request, such as a Hypertext Transfer Protocol (e.g., GET, POST, etc.) or an API call.

FIG. 2 illustrates an example of a framework for a user interface. Example 200 includes an environment 202A, an environment 202B, a user confirmation prompt (a notification) 218A, a notification 218B, a finalization 234, an item 236, units and unit total 238, and an agent 240. The environments 202A-02B, the user confirmation prompt 218A, the notification 218B, the finalization 234, the item 236, the units and unit total 238, and the agent 240 are in accordance with those described elsewhere in this disclosure, such as those described in connection with FIG. 1 and FIG. 3.

The environment 202A and 202B may be an interface, a website, a client device, an application running on a client device of a user, or anything suitable that is able to act as a liaison between the GSP and the user. In the environment 202A and 202B the environment is a GSP service, as discussed in FIG. 1 above. The agent 240 is a browser extension that runs on the browser. The environment 202A and 202B may be an example of, but is not limited to, a checkout or item cart page. The notification 218A may be similar to notification 318, as described in FIG. 3. The notification 218B may be an indication to the user that the SVT is applied, and an SVT code has been generated and applied.

FIG. 3 illustrates an interface 300 on a client device in accordance with an embodiment of the present disclosure. Specifically, FIG. 3 depicts an interface of a client device, such as the client device 104 of FIG. 1, prompting a user to complete a transfer of value (e.g., resource or asset) initiated by a SVT facilitator service, such as the SVT facilitator service 112 of FIG. 1, as a result of detection by the software agent 310 of an opportunity to optimize resources from a GSP service, such as the GSP service 108. The software agent may be an application or extension/plug-in provided by the SVT facilitator service 112 of FIG. 1 installed to the client device 104 to facilitate such transfers. The client device, by virtue of having the software agent downloaded and installed, may receive push notifications from the SVT facilitator service, such as the notification 318, which may be displayed in the interface 300 to alert the user.

The notification 318 may be an indication to the user that an opportunity for resource optimization (e.g., the user's selected items 336 on the interface 304) that fulfills a filter rule has been detected (e.g., by the software agent application). The notification 318 may include a prompt for the user to cause the software agent application on the client device to complete the transfer (exchanging 50 units for a 60-unit SVT) initiated by the user's initiation of finalization actions. Thus, the user's interaction with the interface 304 may cause the client device to continue with the process to complete the transfer.

The items 336 may be virtual or physical goods and/or services. The items 336 depicted in FIG. 3 are for illustrative purposes only and are intended to generically represent items that may be present in the interface 300. Examples of items include clothing items, waste management services, and non-fungible tokens.

The unit type 338 may be any type of unit that can be quantized. The units may be a quantity, monetary value, or other suitable units that can be quantized. In some examples, “quantity” refers to an exact or specified amount or measure, particular/definite amount of something, and/or anything that can be quantized. Examples of units include kilograms (kg), feet (ft), and liters (L). In the illustrative example in FIG. 3, the unit type 338 is a unit of quantity. However, it is contemplated that the unit type 338 may be a symbol for some other medium of transfer, could be spelled out (e.g., “USD,” “EUR,” “CZK,” etc.), or could be some other unit type. For example, the filter rule could be looking for energy resource optimization opportunities and the unit type 524 could be “kilowatt hours,” “megajoules,” or some other unit of energy consumption and/or magnitude. As another example, the filter rule could be an optimization of bandwidth, and the unit type 524 could accordingly be in megabits per second or gigabytes per second, and so on. The clickable finalization 334 may be a control object that, when activated (such as by clicking or tapping), initiates the process without implementing the optimization resource.

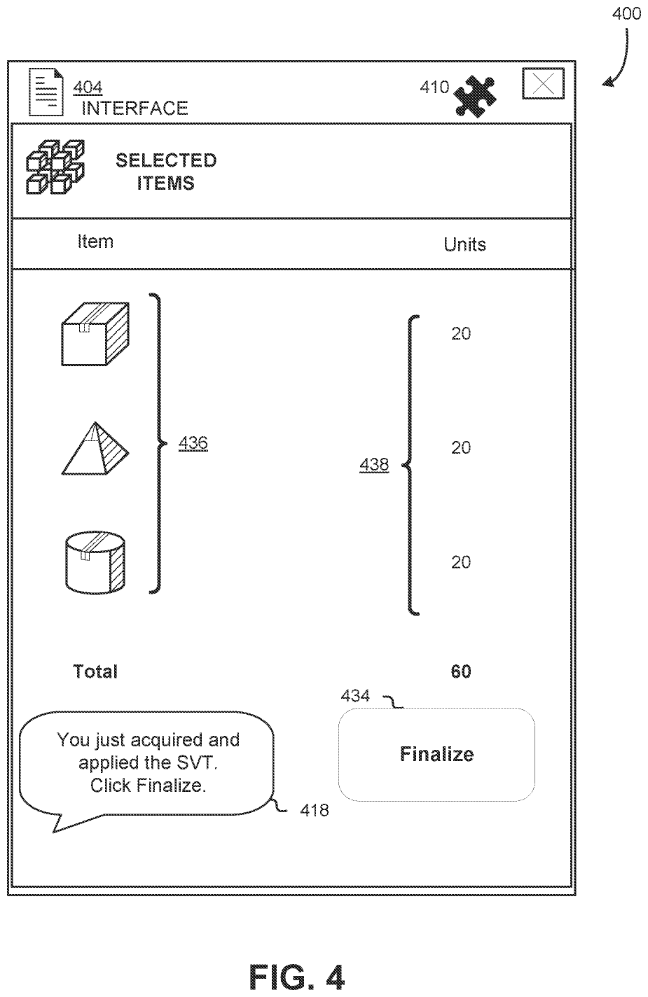

FIG. 4 illustrates an interface 400 on a client device in accordance with an embodiment of the present disclosure. FIG. 4 depicts an illustrative example of an interface 404 of a GSP, such as the GSP service 108, implemented in a software application (such as a web browser or standalone application provided by a SVT facilitator service, such as the SVT facilitator service 112 of FIG. 1) executing on a client device, such as the client device 104 of FIG. 1. Specifically, FIG. 4 depicts an interface of a client device in which a user is notified that a transfer initiated by the SVT facilitator service has occurred as a result of the software agent 410, which may detect an opportunity to optimize resources from the interface. The software application 404, through the interface 400, may allow the user to perform the next step in the process (e.g., checking out of the user's cart on the GSP) after having optimized the user's resources that fulfilled a filter rule monitored by the agent 410 (e.g., the software agent 110).

As noted above, the interface 400 may be an interface of a GSP service, such as the GSP service 108. The interface 400 may be monitored by a software agent, such as the software agent 110 of FIG. 1, provided by the SVT facilitator service so as to detect opportunities for resource optimization on the GSP platform. The interface 400 may be displayed to the user via a browser executing on a client device of the user. In some embodiments, the software agent is a browser extension/plug-in installed to the browser. The interface 400 may include various interface elements to relay information to the user and to allow the user to interact with the software agent executing on the client device. The interface 400 may be provided to the user by the GSP service via a software application (such as a browser) running on the client device. Before requesting any SVTs, however, the software agent running on the client device may require the user to authenticate with the SVT facilitator service, such as by prompting the user to provide proof of possession of credentials (e.g., username and password), provide biometric data (e.g., facial recognition, thumbprint, etc.), perform multi-factor authentication, or some other manner of confirming the user's identity. Once the application has authenticated the user, the software agent may request an SVT for the GSP service on behalf of the user, and the SVT facilitator service may access its data store (e.g., the data store 114 of FIG. 1) for records relating to the user, the GSP service, and SVT issuers.

The items 436 may be virtual or physical goods and/or services, and the items 436 are in accordance with those described elsewhere in this disclosure, such as those described in connection with FIG. 3. The units 438 may be any type of unit that can be quantized, and the units 438 are in accordance with those described elsewhere in this disclosure, such as those described in connection with FIG. 3. The notification 418 may be an indication to the user that an opportunity for resource optimization (e.g., the user's selected items 436 on the interface 404) has been fulfilled, which may be due to a filter rule detection (e.g., by the software agent application 410). The notification 418 may include a notice for the user to initiate finalization actions via the clickable finalization 434. The clickable finalization 434 may be a control object that, when activated (such as by clicking or tapping), initiates the finalization process with the with the application of the SVT.

FIG. 5 illustrates an aspect of a system 500 of an embodiment of the present disclosure. FIG. 5 depicts a representation of an agent 510 as it detects a match to a set of filter rules. As depicted in FIG. 5, the agent 510 has detected the match based on an identity of GSP service 522, a unit type 524, a numeric value 526, and presence of an SVT code field 528. In some examples, a filter rule of the present disclosure may be a set of rules or a search pattern used by the agent 510 to match a particular character string. One example of a filter rule may be a GSP name, number, or URL that corresponds to the particular string that is used to identify a GSP within a database, such as the data store 114 of FIG. 1. It is contemplated that the set of rules may be regular expressions within a set of source code. It is contemplated, however, that other types of filter rule are possible besides regular expressions.

The interface 502 may be an interface to the GSP service “ACME Widgets Inc.,” accessed through a browser, similar to the interfaces depicted in FIGS. 2-4. The agent 510 may be, similar to the software agent 110 of FIG. 1, a third-party service that executes on a client device of a user and monitors interfaces for occasions when an SVT can be used with the GSP services. In some embodiments, the agent 510 may interact with the interface 502 by parsing source code of the interface to identify various form elements (e.g., the Finalize button, the SVT code field 528, the unit type 524, the numeric value 526, etc.) and simulating human interaction (e.g., performing simulated human interaction such as click events, text entry, etc.) with the form elements.

In other embodiments, the agent 510 may have access to the GSP service through an application programming interface provided by the GSP service for use, by the client device 104 of FIG. 1, or by any other suitable medium that may provide such an application programming interface. Such application programming interfaces may allow the agent 510 to search for particular actions and/or GSPs and identify a set of records associated with the use of a particular GSP. When the agent 510 detects a match to a filter rule for particular actions and/or GSPs, the agent 510 may send a notification to the SVT facilitator service that includes an identifier for the user, the identity of the filter rule matched, and other metadata usable by the SVT facilitator service (such as an amount and unit type, entity identifier, item/service identifier, etc., as required).

The identity of GSP service 522 may be a keyword or term associated with an entity, such as the GSP service 108 of FIG. 1. The identity of GSP service may be part of a filter rule, as described above, that the agent 510 monitors for in order to identify opportunities to utilize an SVT.

The filter rule being monitored by the agent 510 may further include a numeric value 526 and/or a unit type 524. The numeric value 526 may be a number indicating an amount of the unit type 524. Although the regular expression filter rule given as an example above is specific to whole numbers, it is contemplated that filter rules using fractional or exponential numbers could be utilized in some implementations.

The unit type 524 may be any type of unit that can be quantized. In the illustrative example in FIG. 5, the unit type 524 is a “€”; however, it is contemplated that the unit type 324 could be a symbol for some other medium of transfer, could be spelled out (e.g., “USD,” “EUR,” “CZK,” etc.), or could be some other unit type. For example, the filter rule could be looking for energy resource optimization opportunities and the unit type 524 could be “kilowatt hours,” “megajoules,” or some other unit of energy consumption and/or magnitude. As another example, the filter rule could be an optimization of bandwidth, and the unit type 524 could accordingly be in megabits per second or gigabytes per second and so on.

The SVT code field 528 may be a field for entering alphanumeric values that correspond to SVTs. The SVT code field 528 may be configured for manual entry of an SVT code, but the agent 510 may simulate human interaction (e.g., performing simulated human interaction using click events and automated text entry) to enter the SVT code into the SVT code field 528.

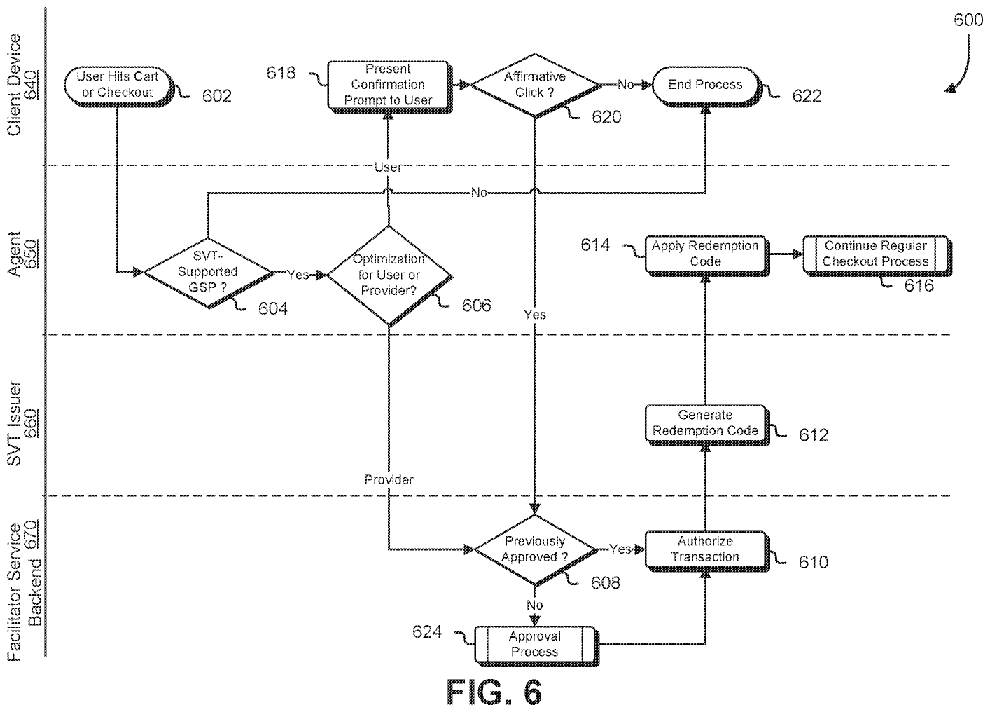

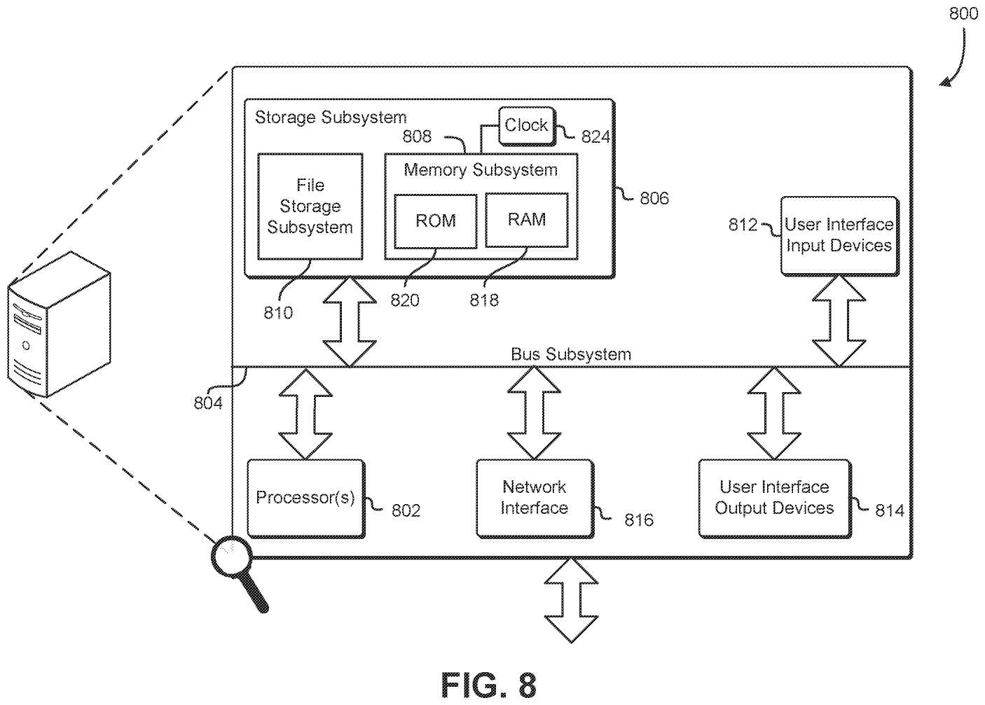

FIG. 6 is a swim diagram illustrating an example of a process 600 for performing a third-party-enabled transfer in accordance with various embodiments. Some or all of the process 600 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 600 may be performed by any suitable system, such as the computing device 800 of FIG. 8. The process 600 includes a series of operations wherein a user completes an action via a client device 640 wherein an agent 650 communicates with an SVT issuer 660 and a SVT facilitator service backend 670 authorizes a transaction and notifies the client device 640.

The client device 640 may be similar to the client device 104 of FIG. 1. The agent may be similar to the software agent 110. The SVT issuer 660 may be similar to one of the SVT issuers 116. The SVT facilitator service backend 670 may be similar to the SVT facilitator service 112. As discussed in the present disclosure, the agent 650 may monitor/track interactions between users and a GSP service platform.

In 602, the user selects to “checkout” or enters on a “cart web page” at the GSP service via the client device 640. The checkout/cart page may include data and/or other characters or values that match a filter rule being monitored for on the GSP service by the agent. For example, the checkout/cart page may have various characteristics, such as a form element with attributes common to SVT code fields, text indicating a “total,” and numeric values next to a unit symbol, that, when taken as a whole, indicate to the agent that the interface is a checkout/cart page that supports application of an SVT.

In 604, the agent 650, having detected a filter rule, determines whether the GSP is identified as an SVT-supported GSP. Because not every checkout/cart page have the same characteristics, determination of a match may be based on a number of characteristics found and adjusted by weights assigned to different characteristics. In some embodiments, the match may be determined based on inputting the characteristics detected into a trained machine learning model and receiving an output in response that exceeds a threshold indicating a likely match to a checkout/cart page that supports application of an SVT.

If the GSP is not SVT-supported, the SVT facilitator service may proceed to perform 622 and end the process. If it is determined that the GSP is SVT-supported then the process moves to 606 to determine the objectives/targets of which resources to optimize, the SVT facilitator services' or the user's. Note that these objectives/targets are illustrative, and additional or alternate objectives/targets or factors may be used depending on implementation. This GSP information regarding its SVT status may be stored in SVT facilitator service's data stores (such as the data store 114 of FIG. 1), on a local data store, or any other suitable locations where data may be stored and accessed.

The determination by the agent of the GSP's SVT status may be at least in part due to the name of the GSP itself, the GSP's website address, or any other suitable information usable to identify the GSP and its status whether it accepts SVTs. It is contemplated that the determination of these identifiers may be done in a variety of ways, such as by referring to a list that the SVT facilitator service has compiled and maintains in data storage (such as the data store 114 of FIG. 1), which maps/correlates entities to the respective web sites or by implementing a software agent, such as an Internet bot, to dynamically utilize an Internet search engine using an application programming interface provided by the search engine provider service or by simulating human interaction with the Internet search engine, to perform a search on the name of the entity. For example, in FIG. 3 the illustrative example of the GSP service is “Domain Name.”

If the website of the GSP service is unfamiliar to the SVT facilitator service, the manner in which value may be transferred from the SVT facilitator service to the entity may not immediately be known to the SVT facilitator service. Thus, in 604, the system performing the process 600 may utilize a machine learning algorithm in the manner described in U.S. patent application Ser. No. 16/744,017, U.S. patent application Ser. No. 16/744,021, U.S. Pat. No. 10,846,106, U.S. patent application Ser. No. 17/101,744, U.S. patent application Ser. No. 16/680,392, U.S. patent application Ser. No. 16/680,396, U.S. patent application Ser. No. 16/680,403, U.S. patent application Ser. No. 16/680,406, U.S. patent application Ser. No. 16/680,408, and U.S. patent application Ser. No. 16/680,410, fully incorporated by reference above, to identify the control functions of the website of the entity.

In 606, the agent 650, having determined the GSP is SVT-supported, determines whether to optimize user's resources or SVT facilitator's resources as its objective/target or some other balance of factors. If it is determined that the SVT facilitator's resources are to be optimized, the process moves to previous approval decision 608. With the decision of SVT facilitator's resource optimization, a percentage of resources is determined and further allocated to the user and to the SVT facilitator, with the SVT facilitator's resource being favored. With the decision of user's resource optimization, a percentage of resources is determined and further allocated to the user and to the SVT facilitator, with the user's resource being favored. Favored may refer to, but is not limited to, a larger ratio of resource granted vs resource utilized. The decision of favoring may be determined by machine learning, a set algorithm, or any other suitable process for determining favorability. If it is determined that the user's resources are to be optimized, the process moves instead to 618.

In 608, the SVT facilitator service backend 670, having determined the SVT facilitator's resources are to be optimized, determines whether the user has previously been approved for a resource advance within the SVT facilitator service backend. The SVT facilitator service backend may determine this through identification through a set of user records. If the user has not been previously approved for a resource advance, the system performing the process moves to 624 to perform an approval process (not illustrated). If the user has previously approved for a resource advance, the process moves to 610.

In 610, the SVT facilitator service backend 670, having determined the user has been previously approved for a resource advance, authorizes the transaction. The process then moves to 612 wherein the SVT issuer 660 generates an SVT code. The SVT code may be a set of numbers, an arrangement of letters, a word, or any other suitable format for an SVT code. The SVT code may or may not be seen or displayed to the user. Following this, the process moves to 614 wherein the agent 650 receives the SVT code and automatically applies the SVT code without need for further user input (e.g., automatically entering the code into an appropriate interface field using simulated human interaction as described in the present disclosure). The process then moves to 616 wherein the agent 650 continues the regular checkout process.

If, however, the agent determines that the user's resources are to be optimized, in 618, the client device 640 presents the confirmation prompt to the user. The process then moves to 620 wherein the client device 640, having presented the confirmation prompt to the user, prompts the user to decide if they would like to optimize their resources. If the user selects to not optimize their resources, the process moves to 622 and therefore, the process ends. If the user instead selects to optimize their resources, the process moves to 608 and the process continues as described in the above description. Note that one or more of the operations performed in 602-22 may be performed in various orders and combinations, including in parallel.

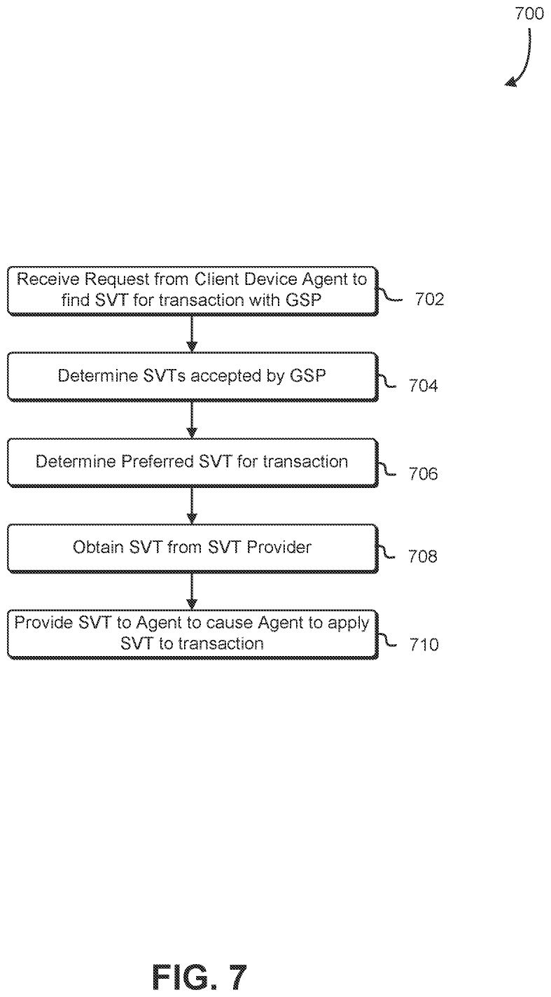

FIG. 7 is a flowchart illustrating an example of a process 700 for performing a third-party-enabled transfer in accordance with various embodiments. Some or all of the process 700 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 700 may be performed by any suitable system, such as the computing device 800 of FIG. 8. The process 700 includes a series of operations wherein a request for an SVT to use with a GSP is obtained from a client device, a set of SVTs that are compatible with the GSP is determined, the preferred SVT from the set of SVTs is determined based on specified objectives/targets or balance of factors, the SVT issuer that issues the SVT is identified and the SVT is requested and obtained from the SVT issuer, and the SVT is provided to the agent running on the client device to cause the agent to apply the SVT to a transaction.

In 702, the system performing the process 700 receives a request from a client device agent (also referred to as a software agent in the present disclosure) to find SVT for a transaction with a GSP. The request may include information regarding the interaction between the user and the GSP service, such as an identifier or other data identifying the GSP, a quantity of units needed for the SVT, an identity of the user and/or user account with the SVT facilitator service, and so on. In some embodiments, the client device agent may require approval from the user prior to submitting the request to the SVT facilitator service.

In 704, the system performing the process 700 determines the SVTs accepted by GSP service. For example, some GSPs accept only SVTs produced by the GSP itself. The GSP itself may be an SVT issuer or may provide the SVT to other third-party issuers. Some GSPs may have agreements to accept other third-party SVTs. The SVT facilitator service may have access to a data store, such as the data store 114, that contains information mapping/correlating various SVTs and their respective SVT issuers to the GSPs that accept them.

In 706, after determining that the GSP accepts SVTs, the system performing the process 700 determines the preferred SVT for transaction. The determination of preferred SVT operates in accordance with the operations of 606 in FIG. 6, as described above.

In 708, after determining whether the user (greatest amount of savings) or the SVT facilitator's resources are to be optimized (e.g, greatest margin for the SVT facilitator), the system performing the process 700 determines an optimal SVT that is available based on the favored optimization. The agent prompts the user whether to apply the optimal SVT to the transaction. The user may indicate approval to apply the SVT through a clickable confirmation, a verbal confirmation, or any other suitable manner of indicating consent depending upon configuration of user device control settings. After receiving approval from the user, the SVT facilitator service obtains the SVT from the determined SVT issuer in exchange for an amount of a resource agreed upon between the SVT facilitator and the SVT issuer. In embodiments, the agreed-upon amount is not more than a face value of the SVT. The SVT may be obtained as an alphanumeric code, a number, or any other suitable format for an SVT as described in the present disclosure. In embodiments, the SVT facilitator may charge an account of the user 102 or request that the user contribute to or reimburse (before or after completion of the transaction) the SVT facilitator for the amount agreed upon between the SVT facilitator and the SVT issuer. In such embodiments, the SVT facilitator may have a profit margin by charging the user 102 more than the agreed-upon amount between the SVT facilitator and the SVT issuer, but the contribution/amount charged to the user 102 may still be less than the face value of the SVT.

In 710, after obtaining the SVT from an SVT issuer, the system performing the process 700 provides the obtained SVT code to the client device agent, which causes the client device agent to automatically enter (e.g., using simulated human interaction) the SVT code into an appropriate form element of a transaction with the GSP. Note that one or more of the operations performed in 702-10 may be performed in various orders and combinations, including in parallel.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

FIG. 8 is an illustrative, simplified block diagram of a computing device 800 that can be used to practice at least one embodiment of the present disclosure. In various embodiments, the computing device 800 includes any appropriate device operable to send and/or receive requests, messages, or information over an appropriate network and convey information back to a user of the device. The computing device 800 may be used to implement any of the systems illustrated and described above. For example, the computing device 800 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 800 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 8, the computing device 800 may include one or more processors 802 that, in embodiments, communicate with and are operatively coupled to a number of peripheral subsystems via a bus subsystem. In some embodiments, these peripheral subsystems include a storage subsystem 806, comprising a memory subsystem 808 and a file/disk storage subsystem 810, one or more user interface input devices 812, one or more user interface output devices 814, and a network interface subsystem 816. Such storage subsystem 806 may be used for temporary or long-term storage of information.

In some embodiments, the bus subsystem 804 may provide a mechanism for enabling the various components and subsystems of computing device 800 to communicate with each other as intended. Although the bus subsystem 804 is shown schematically as a single bus, alternative embodiments of the bus subsystem utilize multiple buses. The network interface subsystem 816 may provide an interface to other computing devices and networks. The network interface subsystem 816 may serve as an interface for receiving data from and transmitting data to other systems from the computing device 800. In some embodiments, the bus subsystem 804 is utilized for communicating data such as details, search terms, and so on. In an embodiment, the network interface subsystem 816 may communicate via any appropriate network that would be familiar to those skilled in the art for supporting communications using any of a variety of publicly available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode and Frame Relay are unreliable connection-oriented protocols. Connection-oriented protocols are in contrast to packet-oriented protocols such as UDP that transmit packets without a guaranteed ordering. Many protocols and components for communicating via such a network are well known and will not be discussed in detail. In an embodiment, communication via the network interface subsystem 816 is enabled by wired and/or wireless connections and combinations thereof.

In some embodiments, the user interface input devices 812 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 800. In some embodiments, the one or more user interface output devices 814 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 800. The one or more user interface output devices 814 can be used, for example, to present user interfaces to facilitate user interaction with applications performing processes described and variations therein, when such interaction may be appropriate.

In some embodiments, the storage subsystem 806 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 806. These application modules or instructions can be executed by the one or more processors 802. In various embodiments, the storage subsystem 806 additionally provides a repository for storing data used in accordance with the present disclosure. In some embodiments, the storage subsystem 806 comprises a memory subsystem 808 and a file/disk storage subsystem 810.

In embodiments, the memory subsystem 808 includes a number of memories, such as a main random-access memory (RAM) 818 for storage of instructions and data during program execution and/or a read only memory (ROM) 820, in which fixed instructions can be stored. In some embodiments, the file/disk storage subsystem 810 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 800 includes at least one local clock 824. The at least one local clock 824, in some embodiments, is a counter that represents the number of ticks that have transpired from a particular starting date and, in some embodiments, is located integrally within the computing device 800. In various embodiments, the at least one local clock 824 is used to synchronize data transfers in the processors for the computing device 800 and the subsystems included therein at specific clock pulses and can be used to coordinate synchronous operations between the computing device 800 and other systems in a data center. In another embodiment, the local clock is a programmable interval timer.

The computing device 800 could be of any of a variety of types, including a portable computer device, tablet computer, a workstation, or any other device described below. Additionally, the computing device 800 can include another device that, in some embodiments, can be connected to the computing device 800 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 800 for processing. Due to the ever-changing nature of computers and networks, the description of the computing device 800 depicted in FIG. 8 is intended only as a specific example for purposes of illustrating the preferred embodiment of the device. Many other configurations having more or fewer components than the system depicted in FIG. 8 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object level interfaces. The computing device 800 may include any appropriate hardware, software and firmware for integrating with a data store as needed to execute aspects of one or more applications for the computing device 800 to handle some or all of the data access and logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 800 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 800 may provide access to content including, but not limited to, text, graphics, audio, video, and/or other content that is provided to a user in the form of HyperText Markup Language (HTML), Extensible Markup Language (XML), JavaScript, Cascading Style Sheets (CSS), JavaScript Object Notation (JSON), and/or another appropriate language. The computing device 800 may provide the content in one or more forms including, but not limited to, forms that are perceptible to the user audibly, visually, and/or through other senses. The handling of requests and responses, as well as the delivery of content, in an embodiment, is handled by the computing device 800 using PHP: Hypertext Preprocessor (PHP), Python, Ruby, Perl, Java, HTML, XML, JSON, and/or another appropriate language in this example. In an embodiment, operations described as being performed by a single device are performed collectively by multiple devices that form a distributed and/or virtual system.

In an embodiment, the computing device 800 typically will include an operating system that provides executable program instructions for the general administration and operation of the computing device 800 and includes a computer-readable storage medium (e.g., a hard disk, random access memory (RAM), read only memory (ROM), etc.) storing instructions that if executed (e.g., as a result of being executed) by a processor of the computing device 800 cause or otherwise allow the computing device 800 to perform its intended functions (e.g., the functions are performed as a result of one or more processors of the computing device 800 executing instructions stored on a computer-readable storage medium).

In an embodiment, the computing device 800 operates as a web server that runs one or more of a variety of server or mid-tier applications, including Hypertext Transfer Protocol (HTTP) servers, FTP servers, Common Gateway Interface (CGI) servers, data servers, Java servers, Apache servers, and business application servers. In an embodiment, computing device 800 is also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python, or TCL, as well as combinations thereof. In an embodiment, the computing device 800 is capable of storing, retrieving, and accessing structured or unstructured data. In an embodiment, computing device 800 additionally or alternatively implements a database, such as one of those publicly available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly expressed or clear from context, means “based at least in part on” and is not limited to “based solely on.”

Conjunctive language, such as phrases of the form “at least one of A, B, and C,” or “at least one of A, B and C,” unless specifically expressed otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A computer-implemented method performed by a stored-value token (SVT) facilitator service that facilitates identifying and obtaining a SVT applicable to a web-based exchange with a vendor that purveys items or services through a website, comprising:
providing, for selection and download over a network by a client device of a user, a software agent capable of applying SVTs to web-based exchanges between users and vendors;
in response to receiving the selection of the software agent from the client device, providing the software agent via the network to the client device for download and installation;
storing, in data storage, a list of providers of SVTs, wherein the list further correlates each provider of the list of providers with at least one vendor that accepts one or more SVTs from the provider;
obtaining, via the network from the software agent executing on the client device, a request for the SVT usable to apply to the web-based exchange, the request indicating the vendor that is facilitating the web-based exchange;
identifying, from the list, a set of SVT providers supported by the vendor;
determining, based on the set of SVT providers and one or more targets, the SVT for the web-based exchange, the SVT representing an advance on a quantity of units of a resource;
causing, by notifying the software agent executing on the client device about the SVT, the client device to prompt the user whether to acquire the SVT for an amount of units;
obtaining, from the software agent executing on the client device, approval to secure the SVT for the amount;
obtaining, by performing an additional exchange with a SVT provider of the set of SVT providers, the SVT from the SVT provider; and
causing, by providing the SVT over the network to the software agent executing on the client device, the software agent to apply at least a portion of the quantity of units of the SVT to an exchange amount of the web-based exchange.

2. The computer-implemented method of claim 1, wherein the one or more targets include at least one of:
a greater difference between the quantity of units and an amount of the units contributed by the user to the SVT facilitator service, or
a lower amount of units needed to be contributed to the SVT provider by the SVT facilitator service to obtain the SVT.

3. The computer-implemented method of claim 1, wherein the additional exchange involves an exchange of value between the SVT facilitator service and the SVT provider, where the exchange of value is less than or equal to the amount of units.

4. The computer-implemented method of claim 1, wherein:
the amount of units and the quantity of units are in the same units of exchange; and
the amount of units is less than the quantity of units of the resource.

5. A system, comprising:
one or more processors; and
memory including computer-executable instructions that, if executed by the one or more processors, cause the system to:
obtain, from a client device via a network, a request for a token that represents an advance of value that is usable in an exchange with a vendor;
determine a set of token providers that provide tokens that are usable in the exchange;
select, based on an objective, the token from the tokens to use in the exchange;
obtain the token from an provider of the token; and
cause, by providing the token over the network to the client device in response to the request, the client device to apply at least a portion of the advance of value to the exchange.

6. The system of claim 5, wherein the objective is one of:
a token with a greater difference than other tokens between the advance of value and an expenditure amount to obtain the token, or
a token with a lower expenditure amount than the other tokens to obtain the token.

7. The system of claim 5, wherein:
the request includes a total amount to be provided to the vendor to complete the exchange; and
the computer-executable instructions that cause the system to cause the client device to apply at least the portion of the advance to the exchange include instructions that cause the client device to apply the at least the portion of the advance to the total amount.

8. The system of claim 5, wherein the computer-executable instructions that cause the system to obtain the token further include instructions that further cause the system to, in response to a transfer to the provider of an agreed-upon amount of resource less than a face value of the token, obtain the token from the provider.

9. The system of claim 5, wherein:
the computer-executable instructions further include instructions that cause the system to maintain, in data storage, information about token providers that provide tokens usable in exchanges; and
the computer-executable instructions that cause the system to determine the set of token providers further include instructions that further cause the system to determine the set of token providers from the information about the token providers in the data storage.

10. The system of claim 5, wherein the computer-executable instructions that cause the system to provide the token over the network to the client device further include instructions that cause the system to provide the token to a software agent executing on the client device.

11. The system of claim 10, wherein the computer-executable instructions further include instructions that further cause the system to provide the software agent over the network to the client device for download and installation.

12. The system of claim 10, wherein the software agent is a browser extension or plug-in.

13. A non-transitory computer-readable storage medium storing executable instructions that, if executed by one or more processors of a computer system, cause the computer system to at least:
receive an indication that a client device is performing an exchange with a vendor;
determine, based at least in part on an identity of the vendor, a set of stored value token (SVT) providers that are supported by the vendor;
determine a set of SVTs provided by the SVT providers;
determine an SVT from the set of SVTs that meets one or more targets regarding the exchange;
obtain the SVT from a corresponding SVT provider; and
cause, by providing the SVT to the client device, the client device to apply the SVT to the exchange.

14. The non-transitory computer-readable storage medium of claim 13, wherein the executable instructions that cause the computer system to obtain the SVT further include instructions that further cause the computer system to:
cause the client device to prompt a user whether to acquire the SVT;
obtain, via the network from the client device, authorization to acquire the SVT for the exchange; and
acquire the SVT from the corresponding SVT provider.

15. The non-transitory computer-readable storage medium of claim 13, wherein the one or more targets include determination of which SVT usable for the exchange has a greater proportional difference between face amount and acquisition amount than other SVTs.

16. The non-transitory computer-readable storage medium of claim 13, wherein:
the indication includes a total amount of a resource needed to complete the exchange;
the SVT represents an advance of the amount of the resource; and
the executable instructions that cause the computer system to cause the client device to apply the SVT to the exchange include instructions that cause the computer system to cause the client device to apply at least a portion of the advance of the amount to the total amount sufficient to complete the exchange.

17. The non-transitory computer-readable storage medium of claim 13, wherein:
the indication further includes a Uniform Resource Locator (URL) for the vendor; and
the executable instructions that cause the computer system to determine the set of SVT providers based at least in part on the identity of the vendor further include instructions that further cause the computer system to filter a list of SVT providers according to the URL to identify the set of SVT providers that provide SVTs acceptable to the vendor.

18. The non-transitory computer-readable storage medium of claim 13, wherein:
the executable instructions further include instructions that further cause the computer system to provide, to the client device, a software agent usable upon execution by the client device, to apply SVTs to exchanges; and
the executable instructions that cause the client device to apply the SVT further cause, by providing the SVT to the software agent executing on the client device, the software agent to apply the SVT to the exchange.

19. The non-transitory computer-readable storage medium of claim 18, wherein the software agent is a browser extension or plug-in.

20. The non-transitory computer-readable storage medium of claim 18, wherein the software agent executes as a standalone software application on the client device.
